(19) United States
(12) Patent Application Publication
(10) Pub. No.: US 2007/0144756 A1
(43) Pub. Date: Jun. 28, 2007

(54) Hose for conveying media that generate electrostatic charges, especially powdery media

(75) Inventors: Rudolf Wenger, Hittnau (CH); Peter Waibel, Alt St. Johann (CH); Werner Zimmermann, Dubendorf (CH)

Correspondence Address: THE WEBB LAW FIRM, P.C., 700 KOPPERS BUILDING, 436 SEVENTH AVENUE, PITTSBURGH, PA, 15219, US

(73) Assignee: HUBERAG, Herisau (CH)

(21) Appl. No.: 10/579,015

(22) PCT Filed: Sep. 21, 2004
(86) PCT No.: PCT/CH04/00594

§ 371 Date: Feb. 20, 2007

(30) Foreign Application Priority Data
Nov. 12, 2003 (CH) 01948/03

(51) Int. Cl. H01B 7/00

(52) U.S. Cl. 174/47; 138/103

(57) ABSTRACT

A hose for conveying media that generate electrostatic charges, wherein the hose includes a hose wall enclosing an interior delimited by an inner surface, wherein the hose wall is constructed from a flexible, electrically poor conductive or non-conductive base material, and at least one electric line element extending in the longitudinal direction of the hose and being integrated into the hose wall to dissipate electric charged, wherein at least one region of a cross section of the hose wall adjoining the interior of the hose has an electrical conductivity greater than the base material, and wherein the at least one electric line element is directly connected to the region of increased electrical conductivity. In such a hose, improved dissipation of the charges without impairing the remaining hose properties is achieved.

### TECHNICAL FIELD

The present invention pertains to the field of conveying technology. It relates to a hose for conveying media that generate electrostatic charges, especially powdery media, according to the preamble of claim 1.

### PRIOR ART

In powder coating, a powder-air mixture is usually supplied to a spray gun via a feed line. The powder particles emerge from the gun as electrically charged particles and are deposited from a powder cloud onto the surface of the workpiece to be coated. The workpiece is grounded for this purpose. The powder particles can be charged positively or negatively, depending on the technique used. A negative charge on the powder particles is achieved for example by a high voltage electrode arranged on the gun outlet (what is known as “corona charging”). A positive charge on the powder particles can be generated in the case of suitable powders by means of frictional charging in the powder tube of the gun (what is known as “tribo charging”).

The powders (for example paint powders) used in powder coating are conveyed to the spray gun from a storage container via hoses by using clean compressed air. The hoses used are transparent plastic hoses, which are flexible and kink-resistant and permit visual monitoring of the conveying operation.

As a result of the friction of the powder particles of the conveyed powder-air mixture on the walls of the hoses, consisting of electrically insulating material, static electric charges are built up on the walls of the hoses, which cannot flow away without special precautions. On account of such charges, it is possible for flashovers to occur in the hose region, which damage the hose and, possibly, cause it to become leaky and, furthermore, are associated with the risk of ignition of the conveyed material.

Undesired charging processes in the conveying hoses are not restricted to powder-air mixtures of powder coating plants but occur in many other sectors where powdery substances, but also liquids (for example fuels), are conveyed in electrically insulating hoses.

For this reason, a large number of proposals have been made in the past, with which the problem of static electric charging during the conveyance of an extremely wide range of media through hoses is intended to be solved. All these proposals contain measures with which the electric charges building up on the hose wall can be carried away and therefore made non-damaging.

U.S. Pat. No. 5,170,011 discloses a fuel hose comprising two concentric sheaths in which, in order to dissipate electric charges, either an electrically conductive strip extending in the longitudinal direction is provided, which is let into the wall of the inner sheath and reaches in the radial direction through the wall of the inner sheath (FIG. 1), or a concentric layer of electrically conductive material is arranged on the inner surface of the inner sheath (FIG. 2). However, the entire inner sheath can also be configured to be electrically conductive (column 5, lines 27-51). In all cases, the electrical conductivity is achieved by using carbon black, although reference is made to the possibility of other conductive additives.

U.S. Pat. No. 3,473,087 and GB-A-1,041,255 disclose pipes and hoses made of polytetrafluoroethylene (PTFE) for the conveyance of liquids, in particular fuels, which are produced from a preform which comprises two concentric regions, of which the inner has been made electrically conductive by the addition of carbon black, while the outer remains electrically insulating. The hoses produced in this way have a comparatively thin-walled, concentric inner region which is electrically conductive as a result of the addition of carbon black and which can be used to dissipate static electric charges. By restricting the addition of carbon black to the inner region, in one case (GB-A-1,041,255), the transparency of the outer hose wall is maintained for purposes of the visual inspection of the hose. In the other case (U.S. Pat. No. 3,473,087), the resistance of the hose to what is known as “fuel cracking” is intended to be largely maintained.

Furthermore, it is known from U.S. Pat. No. 3,555,170 to embed in a flexible hose of electrically insulating material for the conveyance of liquids or powders a conductor strip extending in the longitudinal direction, which has the form of a woven fabric made of fine metal wire and elastic yarn. The conductive strip can in this case be arranged on the outside, in the center of the hose wall or on the inside.

Finally, EP-A2-0 974 779 discloses a hose for conveying free-flowing substances, such as coating powders, of which the wall consists of an electrically non-conducting or poorly conducting material. In order to dissipate electric charges, a wall part of electrically conductive material is incorporated into the hose wall, extends radially over the wall cross section and axially over the length of the hose and substantially has a cross section in the shape of a circular sector. The electrically conducting wall part preferably consists of metal wire or stranded metallic wire. Alternatively, it can consist of a plastic made conductive by the addition of carbon. The electrically conductive wall part can run axially parallel in the axial direction or helically around the axis.

The known hoses with their devices for dissipating electric charges are alternatively equipped either with an axially continuous concentric layer or an axially continuous concentric region with an electrical conductivity which is increased as compared with the base material (U.S. Pat. No. 3,473,087; GB-A-1,041,255) or have a localized strip-like or wire-like conductor element which is integrated into the electrically insulating hose wall and which extends in the axial direction (U.S. Pat. No. 3,555,170; EP-A2-0 974 779). The two alternatives are compared in U.S. Pat. No. 5,170,011 (FIG. 1 and FIG. 2).

Each of the two alternatives has advantages and disadvantages: If a concentric part of the hose wall is made electrically conductive by the addition of electrically conductive particles in order to dissipate the electric charges, as a rule not only the electrical but also the mechanical and optical properties of the wall part are changed. The higher the percentage proportion of the particles, the better is the electrical conductivity, on the one hand, but the more the remaining properties also change. If, for example, carbon black is added as electrically conductive material, an originally optically transparent hose loses its transparency with an increasing proportion of carbon black. Although the thickness of the electrically conductive layer can be reduced as a countermeasure, as has been proposed in GB-A-1,041,255, at the same time the line cross section of the electrically conductive region decreases.

If, instead of the concentric electrically conductive part of the hose wall, a conductive strip or stranded conductor or, as in EP-A2-0 974 779, a localized electrically conductive wall part is used, the physical properties of the hose remain unchanged over virtually the entire hose wall. On the other hand, limiting the electrically conductive element to a very small region of the wall cross section results in the charges arising on the inner surface of the hose as a result of friction being collected only very incompletely over the entire inner circumference and its not being possible to dissipate them.

### SUMMARY OF THE INVENTION

It is therefore an object of the invention to provide a hose for conveying media that generate electrostatic charges, especially powdery media, which overcomes the disadvantages of known solutions and is distinguished in particular by improved dissipation of the electric charges, at the same time with a reduced change in the hose properties.

The object is achieved by all of the features of claim 1. The nub of the invention is to equip a region of the hose wall adjoining the interior of the hose with an electrical conductivity that is increased as compared with the base material, and to lead the charges collected by this region away in the axial direction by means of at least one electric line element which is connected directly to the region of increased electrical conductivity. The interaction of the region of increased electrical conductivity with the electric line element causes effective collection and dissipation of the electric charges with a change in the remaining hose properties which is reduced to a minimum. The region of increased electrical conductivity, which has a great influence on the hose properties, can manage with comparatively small proportions of an electrically conductive material, since it is intended to collect the charges only on the inner surface of the hose and to lead them to the line element. The closely localized electric line element, which has little influence on the hose properties, can on the other hand be equipped with comparatively high electrical conductivity and in this way bring about effective axial dissipation without any detrimental influence on the hose properties.

A first preferred refinement of the hose according to the invention is distinguished by the fact that the region having the increased electrical conductivity extends over the entire hose wall, and by the fact that the increased electrical conductivity of the hose wall is brought about by electrically highly conductive particles embedded in the base material. Such a hose, having uniformly dispersed electrically conductive particles, can be produced particularly simply, since no subdivision of the hose wall into concentric subregions is necessary. However, since the particles are distributed uniformly over the entire wall thickness of a hose, the result is in particular a relatively intense decrease in the optical transparency with an increasing proportion of particles. This effect is particularly intense if electrically conductive particles in powder, granular, spherical or flock form, such as carbon black, are used, since in this case a relatively high particle density is necessary in order to achieve continuous electrical conductivity.

A particularly advantageous development of this refinement is distinguished by the fact that the base material is an optically transparent polymer, in particular PU, PE or PVC, by the fact that short, electrically highly conductive fibers, in particular carbon fibers, are embedded in the base material as the electrically highly conductive particles, and by the fact that the concentration of the fibers is chosen such that the hose wall remains optically transparent in the radial direction. Since the fibers located crossed and transversely in the base material remain in contact with one another over a relatively great distance, good electrical conductivity can be achieved with them, even with a relatively low density. Given the same electrical conductivity, the hose properties are much less influenced by the fibers than in the case of other particle forms. About 1 to 3% by weight of carbon fibers or conductive carbon particles (for example carbon black) are preferably added to the base material.

Furthermore, inlaying fibers or carbon fibers into the base material of the hose wall specifically has consequences for the surface structure of the hose wall which are particularly advantageous, especially when the hose is used for conveying powdery substances. This is because, in practice, it has transpired that, in hoses with a smooth inner surface, the powder conveyed often adheres to the inner surface and then impairs the conveying process. Although the pressure of the compressed air used for the conveyance, and therefore the air stream, can be increased as a countermeasure, this leads to increased production costs, since cleaned compressed air is relatively expensive. However, the effect of powder adhesion, associated with a predominantly laminar flow, can also be combated or eliminated by the inner surface being provided with a certain surface roughness. The effectiveness of the surface roughness depends highly on the type and configuration of the roughness, however; if the roughness is sharp-edged or jagged, although the adhesion of the powder is made more difficult, conveying pressures that are increased more and more are necessary in this case.

On the other hand, if short fibers are inlaid in the base material, the embedded fibers at the surface lead to a uniform, easily controllable roughness with highly rounded irregularities which, firstly, reliably prevents adhesion of the powder to the surface but, secondly, also hampers the flow through the hose only minimally, so that it is possible to operate with minimum conveying pressures during the conveyance. If the embedding of the fibers is restricted only to an inner subregion of the hose wall, as is the case in an abovementioned refinement of the invention, the outer surface of the hose remains smooth, since the outer regions of the hose wall are free of embedded fibers. This has the substantial advantage that the hose can be cleaned particularly easily on the outside.

The at least one electric line element can be formed as a line region let into the hose wall and having an electrical conductivity that is increased considerably as compared with the base material, in particular the line region that is let in being formed so as to be continuous in the radial direction through the hose wall.

However, the at least one electric line element can also be formed as a wire or stranded conductor let into the hose wall, the wire or stranded conductor preferably being at a distance from the inner surface of the hose which corresponds approximately to one third of the wall thickness of the hose wall.

Furthermore, in order to produce a certain rotational symmetry, it may be advantageous for the line region or the wire or stranded conductor in the hose wall to run helically around the hose axis in the longitudinal direction.

The properties of the hose wall are influenced particularly little if, according to another refinement of the invention, the region having the increased electrical conductivity is restricted to a concentric inner region of the hose wall that adjoins the inner surface, or if the region having the increased electrical conductivity is formed by an inner sheath arranged concentrically in the interior of the hose, in this case, too, the increased electrical conductivity in the inner region or in the inner sheath of the hose wall preferably being brought about by electrically highly conductive particles embedded in the base material, and by the base material being an optically transparent polymer, in particular PU, PE or PVC, short, electrically highly conductive fibers, in particular carbon fibers, being embedded in the base material as the electrically highly conductive particles, and the concentration of the fibers and/or the thickness of the inner region or of the inner sheath being chosen such that the hose wall remains optically transparent in the radial direction. The fact that the region of increased electrical conductivity adjoins the inner surface means not only that the electric charges arising there can be collected effectively and carried away by the electric line element, but that here, too, the inlaid fibers again ensure an inner surface with a surface roughness which is controlled and optimal with regard to the flow conditions.

The at least one electric line element is preferably formed as a line region let into the hose wall and having an electrical conductivity that is increased considerably as compared with the base material, the line region that is let in preferably being formed so as to be continuous in the radial direction from the outer surface as far as the inner region or inner sheath.

It is particularly advantageous with regard to construction and dissipation behavior if the at least one electric line element is formed as a wire or stranded conductor let into the hose wall (12), the wire or stranded conductor preferably running at the interface between the inner region (20) or the inner sheath and the remaining hose wall.

Here, too, the line region or the wire or stranded conductor in the hose wall can run helically around the hose axis in the longitudinal direction.

Another preferred embodiment of the invention is distinguished by the fact that the at least one electric line element is formed as a wire or stranded conductor let into the hose wall, by the fact that the wire or stranded conductor is at a distance from the inner surface of the hose, and by the fact that the region having the increased electrical conductivity is formed as a local line region enclosing the electric line element, the increased electrical conductivity of the hose wall preferably being brought about by electrically highly conductive particles embedded in the base material, and the wire or stranded conductor in the hose wall running helically around the hose axis in the longitudinal direction. The line region of reduced size improves the optical transparency of the hose, so that the material flow in the hose can be monitored still better from outside. By means of the shaping of the line region enclosing the wire or stranded conductor, the risk of powdered material transported in the hose caking on the electrically conductive section of the inner surface can also be reduced.

The line region that encloses the electric line element can in this case be formed in a particularly simple way concentrically with the electric line element.

It is still more beneficial if the line region that encloses the electric line element has a teardrop-shaped cross section, of which the tip adjoins the interior of the hose. The chosen teardrop shape of the cross section is an optimum between the best possible dissipation of the electrostatic charge and the smallest possible conductive surface on the inner surface of the hose.

It has proven to be particularly worthwhile if the base material of the hose is a polyolefin elastomer.

The hose according to the invention can be used with particularly good results for the conveyance of coating powders.

### BRIEF EXPLANATION OF THE FIGURES

The invention is to be explained in more detail in the following text using exemplary embodiments in conjunction with the drawing, in which:

FIG. 1 shows an exemplary hose, such as is used for conveying paint powders or the like, in a perspective side view;

FIG. 2 shows an enlarged sector-shaped detail from the hose wall of the hose according to FIG. 1, in which the inner surface of the hose wall has irregularities for improving the powder transport;

FIG. 3 shows a further enlarged detail from the inner side of the hose wall of the hose from FIG. 1, in which the irregularities of the inner surface of the hose produced by fibers inlaid in the hose material are visible;

FIG. 4 shows, in two partial figures, the hose cross sections of two different exemplary embodiments of hoses according to the invention, in which the electrically conductive particles added to the hose material are distributed uniformly over the entire cross section, in the one example (FIG. 4a) a line region extending in the longitudinal direction and, in the other example (FIG. 4b), a stranded conductor extending in the longitudinal direction being provided in order to dissipate the charges;

FIG. 5 shows, in two partial figures, two further, mutually different, exemplary embodiments of hoses according to the invention, in which the electrically conductive particles added to the hose material are restricted to an inner region around the inner surface, in the one example (FIG. 5a) a plurality of line regions extending in the longitudinal direction and, in the other example (FIG. 5b), a plurality of wires extending in the longitudinal direction being provided in order to dissipate the charges;

FIG. 6 shows, in two partial figures, the hose cross sections of two other, mutually different, exemplary embodiments of hoses according to the invention, in which the electrically conductive particles added to the hose material are introduced into an inner sheath arranged within the hose, in the one example (FIG. 6a) a line region extending in the longitudinal direction and, in the other example (FIG. 6b), a stranded conductor extending in the longitudinal direction being provided in order to dissipate the charges;

FIG. 7 shows the cross section through a hose according to another exemplary embodiment, in which a wire or a stranded conductor is surrounded concentrically by a local line region which adjoins the inner surface; and

FIG. 8 is an illustration comparable with FIG. 7, of another embodiment in which a wire or stranded conductor is surrounded by a local line region having a teardrop-shaped cross section, of which only the tip adjoins the inner surface.

### WAYS OF IMPLEMENTING THE INVENTION

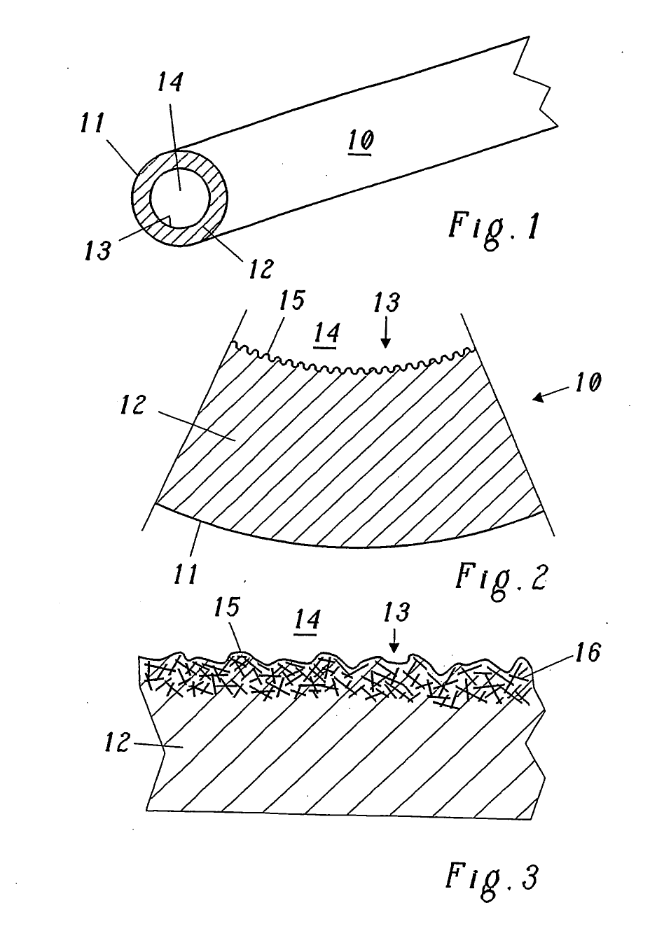

FIG. 1 shows a perspective side view of an exemplary hose 10, as is used for conveying paint powders or the like and is the subject of the present invention. The hose 10 is normally made of an optically transparent polymer, in particular of polyurethane (PU), polyethylene (PE) or polyvinyl chloride (PVC), or else of polytetrafluoroethylene (PTFE). However, it can also be produced from another flexible, electrically insulating material. The hose 10 comprises an annular hose wall 12, which encloses an interior 14. Toward the interior 14, the hose wall 12 is bounded by an inner surface 13, and toward the surrounding outer space by an outer surface 11. Examples of dimensions for the hose are an internal diameter of 10 mm and a thickness of the hose wall of 3 mm. Other dimensions are possible, depending on the area of use and the mass stream to be conveyed.

The following requirements are placed on the hose 10, in particular when it is used for conveying coating powder in the form of a powder-air mixture:
The inner surface 13 should, according to FIG. 2, have a specific roughness, caused by irregularities 15, in order that the powder conveyed cannot adhere to the inner surface and thus impair the conveyance (the irregularities 15 in FIG. 2 are shown as completely uniform for simplicity; in fact, these irregularities are non-uniform, however, as can be seen in the detail of FIG. 3).
The electrostatic charges generated on the hose wall during the conveyance of the coating powder or another medium should be dissipated to ground in a safe manner.
The hose wall 12 should be optically transparent, in order that the conveying process can be monitored visually.
The hose should be flexible and, at the same time, kink-resistant down to a defined minimum radius.
The hose should have a smooth outer surface 11 that is as easy to clean as possible.
The hose should be abrasion-resistant, in particular when it is provided for conveying powders.
The hose should be resistant to oils and hydrocarbons.
If the hose is used in the region of foodstuff production and processing, it must be foodstuff compliant.

These requirements are fulfilled in the case of a hose which, for example, consists of PU, PE or PVC as a base material and in which a combination of two electrically conductive devices is provided in order to dissipate the electrostatic charges. The one electrically conductive device is a region of the hose wall which surrounds the interior 14 concentrically and is delimited by the inner surface 13 and which, as a result of embedding electrically conductive particles in the base material, is equipped with an electrical conductivity which is increased considerably as compared with the base material. The other electrically conductive device is a local electric line element running in the axial direction, which is connected directly to the region of increased electrical conductivity and which carries away the charges collected by this region safely to ground in the axial direction.

Delimiting the region of increased electrical conductivity or the region having the embedded electrically conductive particles by means of the inner surface 13 has the following special advantage, which becomes clear from FIG. 3:

FIG. 3 shows, in a greatly enlarged detail, part of the hose wall 12 surrounding the interior 14 with its delimitation by the inner surface 13. Short fibers 16, in particular in the form of carbon fibers, are embedded in the base material of the hose wall 12 (hatched) as electrically conductive particles. The fibers 16 are distributed and oriented irregularly. On account of their elongated form, which permits contact between two fibers over a relatively large distance, a comparatively low fiber concentration in the base material results in a considerably increased electrical conductivity. As a result, the desired electrical conductivity in the base material can be set without expectations with regard to the optical transparency of the hose wall 12 having to be lowered excessively.

The embedded fibers 16 also have the effect that random irregularities 15 are produced in the delimiting inner surface 13 and impart roughness to the inner surface 13. Since the base material envelops the fibers 16 projecting from the surface in a flowing manner, these irregularities 15 are rounded. As compared with sharp-edged irregularities, such as are produced for example when a soft surface is separated from a mold, this has the advantage that, although the adhesion of conveyed powdery media is reliably avoided, the flow behavior is otherwise influenced only little. Furthermore, the surface roughness produced by the fibers 16 or other particles may be controlled and set very well in process engineering terms. The base material is preferably a thermoplastic polyurethane (TPU), with which 1 to 3% by weight of carbon fibers are added to the region having the increased electrical conductivity.

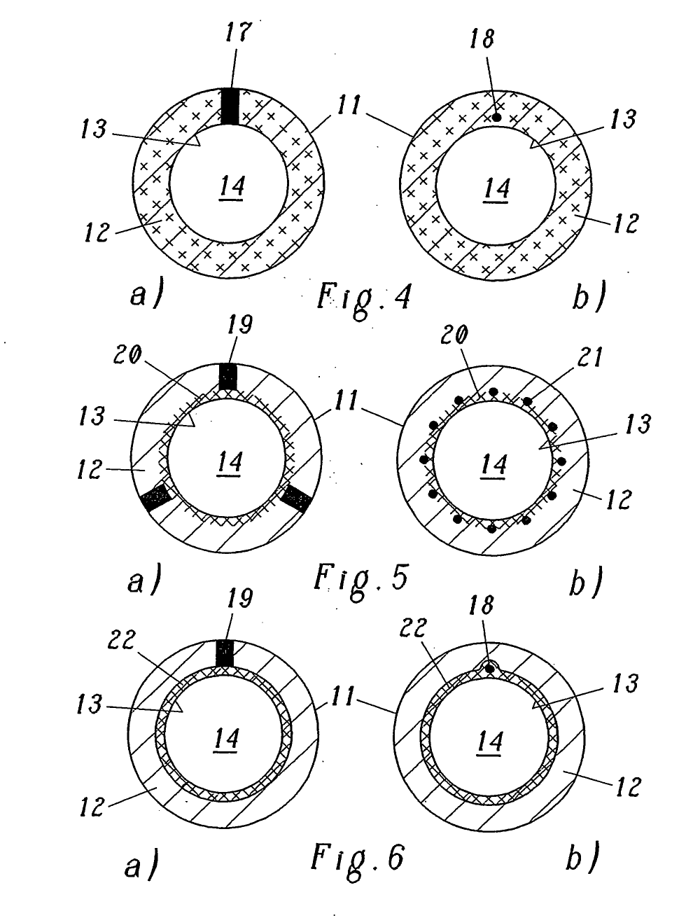

The two electrically conductive devices that are connected to each other can now be formed in different ways. Six different exemplary embodiments of their formation are reproduced in FIGS. 4a, b to 6a, b. The two examples shown in FIG. 4 have the common factor that, therein, the region of increased electrical conductivity extends over the entire cross-sectional area of the hose wall 12. The electrically conductive particles or fibers inlaid in the base material are symbolized in FIG. 4 by the crosses within the hatched region.

In the example of FIG. 4a, the electric line element in the hose wall 12 is a line region 17 extending in the axial direction. The line region 17 is comparable with the wall part disclosed in EP-A2-0 974 779 or in U.S. Pat. No. 5,170,011 (FIG. 1) and can be produced by filling with carbon black or the like. The line region 17 carries away to the outside the electric charges collected by the hose wall 12 that has been made conductive. Instead of one line region 17, two or more line regions distributed over the circumference can be arranged, as can be seen by way of example in FIG. 5a for n=3. The line region 17 reaches in the radial direction through the hose wall 12 from the inner surface 13 to the outer surface 11. If direct contact between the line region 17 and the material conveyed in the interior 14 is not desired, the line region can also end in the hose wall, as can be seen in FIG. 5a.

In the example of FIG. 4b, in order to dissipate the charges into the hose wall 12, a wire or stranded conductor 18 extending in the axial direction is provided, which is at a distance from the inner surface 13 in the radial direction which preferably corresponds approximately to one third of the wall thickness. A stranded conductor 18 which has proven to be worthwhile is a stranded wire made of copper wires which is reinforced with Kevlar filaments. The stranded conductor 18 is embedded directly in the hose wall 12 as the hose 10 is extruded. Instead of the one stranded conductor 18, two or more distributed over the circumference can also be provided, as can be seen in the case of the wires 21 from FIG. 5b. For reasons of symmetry, the line region 17 or the stranded conductor 18 in the hose wall 12 can run helically around the hose axis in the longitudinal direction.

Since, in the examples of FIG. 4, the entire hose wall 12 is filled with electrically conductive particles or fibers, the effects of the particle concentration on the optical transparency are particularly great. Furthermore, the entire hose has to be produced from the comparatively expensive filled polymer, which leads to increased costs in spite of the simple production. These problems can be circumvented if the hose has a configuration as illustrated in the exemplary embodiments of FIGS. 5 and 6. In the examples of FIGS. 5a, b and 6a, b, the region of the hose wall 12 having an increased electrical conductivity is restricted in the radial direction to a thin inner region 20 (FIGS. 5a, b) or inner sheath 22 (FIGS. 6a, b). A hose having a more highly conductive inner region 20 (cross-hatching) can be produced from a corresponding preform, as described in GB-A-1,041,255. The inner region 20 has a thickness of 1 mm, for example. In FIG. 5a, the electric line elements provided are three axial line regions 19, which reach from the outer surface 11 through the hose wall 12 as far as the inner region 20 and are arranged distributed uniformly over the circumference. Instead of the three line regions 19, only one line region can also be provided. In FIG. 5b, at the boundary between the inner region 20 and the non-filled region of the hose wall, a plurality of wires 21 are arranged distributed around the circumference. The wires 21 can be part of a braid, but which must be designed to be sufficiently loose in order to obtain the optical transparency. Of course, a stranded conductor can also be used in this case, as in FIG. 4b.

Finally, the two exemplary embodiments of FIG. 6 have as a region with increased electrical conductivity an inner sheath 22, which is preferably produced by coextrusion during the production of the hose. Here, too, the electric line element provided can again be a line region 19 or a stranded conductor 18 extending axially. In order to produce a good electrical contact with respect to the inner sheath 22, the stranded conductor 18 is preferably enclosed completely by the material of the inner sheath 22.

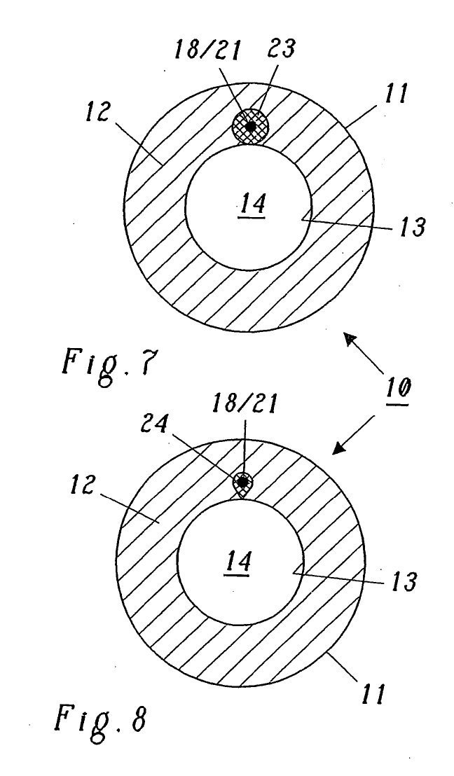

Two further exemplary environments of the invention are reproduced in FIGS. 7 and 8. The dissipation of the electrostatic charge in the longitudinal direction of the hose 10 is carried out here by a wire 21 or stranded conductor 18 with its high conductivity, while the dissipation from the inner surface 13 of the hose 10 to the wire 21 or stranded conductor 18 is carried out by a line region 23 or 24 which surrounds the wire 21 or stranded conductor 18 and adjoins the interior 14 of the hose. In the exemplary embodiment of FIG. 7, the line region 23 surrounds the wire 21 or stranded conductor 18 concentrically and reaches the surface only in a closely delimited region of the inner surface 13. In the exemplary embodiment of FIG. 8, the line region 24 has a teardrop-shaped cross section with a tip which points radially inward and adjoins the interior 14. As a result of the closely delimited region of the inner surface 13 on which the line region 23, 24 meets the surface, the risk of caking of the powdery material conveyed in the hose 10 can be reduced. The risk is particularly low in the case of the line region 24 having the teardrop-shaped cross section.

The increased electrical conductivity of the hose wall 12 in the line regions 23, 24 is preferably brought about by the electrically highly conductive particles embedded in the base material. The wire 21 or stranded conductor 18 in the hose wall 12 preferably also runs helically around the hose axis in the longitudinal direction.

The inner surface 13 of the hose 10 is also rough in this case. The roughness is influenced in a controlled way by the extrusion parameters during the production of the hose 10. On the other hand, the outer surface 11 remains smooth, which improves the optical transparency. A further improvement in the optical transparency results from the close delimitation of the line regions 23 and 24 to the immediate surroundings of the wire 21 or stranded conductor 18.

It has proven to be particularly worthwhile if the base material of the hose is a polyolefin elastomer.

Overall, the invention results in a hose which is specifically suitable for the conveyance of powders and is distinguished by the following advantages:
As a result of the optimally rounded roughness of the inner surface, it is possible to operate with minimum conveying pressures, which result in a substantial reduction in costs, since the compressed air needed for the conveyance is relatively expensive.
Precisely in the case of powder coating plants, in spite of a reduced conveying pressure, the novel hoses result in a better expulsion performance and also a more uniform application of the powder.
As a result of the conductive regions of the hose wall and the incorporated electric line element (ground wire or stranded wire), charging or overvoltage generated by friction can be dissipated optimally.
The optical transparency of the hose is largely maintained.

### LIST OF DESIGNATIONS

10 Hose
11 Outer surface (hose)
12 Hose wall
13 Inner surface (hose)
14 Interior (hose)
15 Irregularity
16 Fiber (electrically conductive, e.g. carbon fiber)
17, 19 Line region
18 Stranded conductor
20 Inner region
21 Wire
22 Inner sheath
23, 24 Line region

1-26. (canceled)

27. A hose for conveying media that generate electrostatic charges, wherein the hose comprises a hose wall enclosing an interior delimited by an inner surface, wherein the hose wall is constructed from a flexible, electrically poor conductive or non-conductive base material, and at least one electric line element extending in the longitudinal direction of the hose and being integrated into the hose wall to dissipate electric charges, wherein at least one region of a cross section of the hose wall adjoining the interior of the hose has an electrical conductivity greater than the base material, and wherein the at least one electric line element is directly connected to the region of increased electrical conductivity.

28. The hose as claimed in claim 27, wherein the region having the increased electrical conductivity extends over the entire hose wall.

29. The hose as claimed in claim 28, wherein the electrically highly conductive particles embedded in the base material cause the increased electrical conductivity of the hose wall.

30. The hose as claimed in claim 29, wherein the base material is an optically transparent polymer, wherein the electrically highly conductive particles are electrically highly conductive fibers and wherein the concentration of the fibers is chosen such that the hose wall remains optically transparent in the radial direction.

31. The hose as claimed in claim 30, wherein about 1 to 3% by weight of carbon fibers are added to the base material.

32. The hose as claimed in claim 28, wherein the at least one electric line element is formed as a line region let into the hose wall and having an electrical conductivity that is greater than the base material.

33. The hose as claimed in claim 32, wherein the line region that is let in is formed so as to be continuous in the radial direction through the hose wall.

34. The hose as claimed in claim 28, wherein the at least one electric line element is formed as a wire or stranded conductor let into the hose wall.

35. The hose as claimed in claim 34, wherein the wire or stranded conductor is disposed at a distance from the inner surface of the hose that corresponds approximately to one third of the wall thickness of the hose wall.

36. The hose as claimed in claim 34, wherein the line region or the wire or stranded conductor in the hose wall runs helically around the hose axis in the longitudinal direction.

37. The hose as claimed in claim 27, wherein the region having the increased electrical conductivity is restricted to a concentric inner region of the hose wall that adjoins the inner surface.

38. The hose as claimed in claim 27, wherein the region having the increased electrical conductivity is formed by an inner sheath arranged concentrically in the interior of the hose.

39. The hose as claimed in claim 38, wherein the electrically highly conductive particles embedded in the base material cause increased electrical conductivity in the inner region or in the inner sheath of the hose wall.

40. The hose as claimed in claim 39, wherein the base material is an optically transparent polymer, wherein the electrically highly conductive particles are electrically highly conductive fibers and wherein the concentration of the fibers or the thickness of the inner region or of the inner sheath is chosen such that the hose wall remains optically transparent in the radial direction.

41. The hose as claimed in claim 37, wherein the at least one electric line element is formed as a line region let into the hose wall and having an electrical conductivity that is greater than the base material.

42. The hose as claimed in claim 41, wherein the line region that is let in is formed so as to be continuous in the radial direction from the outer surface as far as the inner region or inner sheath.

43. The hose as claimed in claim 37, wherein the at least one electric line element is formed as a wire or stranded conductor let into the hose wall.

44. The hose as claimed in claim 43, wherein the wire or stranded conductor runs at an interface between the inner region or inner sheath and a remaining portion of the hose wall.

45. The hose as claimed in claim 43, wherein the line region or the wire or stranded conductor in the hose wall runs helically around the hose axis in the longitudinal direction.

46. The hose as claimed in claim 27, wherein the at least one electric line element is formed as a wire or stranded conductor let into the hose wall, in that the wire or stranded conductor is disposed at a distance from the inner surface of the hose, and in that the region having the increased electrical conductivity is formed as a local line region enclosing the electric line element.

47. The hose as claimed in claim 41, wherein the electrically highly conductive particles embedded in the base material cause increased electrical conductivity of the hose wall.

48. The hose as claimed in claim 46, wherein the wire or stranded conductor in the hose wall runs helically around the hose axis in the longitudinal direction.

49. The hose as claimed in claim 46, wherein the line region that encloses the electric line element is formed concentrically with the electric line element.

50. The hose as claimed in claim 46, wherein the line region that encloses the electric line element has a teardrop-shaped cross section, wherein a tip thereof adjoins the interior of the hose.

51. The hose as claimed in claim 27, wherein the base material of the hose is a polyolefin elastomer.
